(19) United States
(12) Patent Application Publication
(10) Pub. No.: US 2005/0198283 A1
(43) Pub. Date: Sep. 8, 2005

(54) Managing a network using generic policy definitions

(76) Inventors: Sundaresan Ramamoorthy, San Jose, CA (US); Roopa Shankar, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/751,899

(22) Filed: Jan. 7, 2004

(51) Int. Cl. G06F 15/173; G06F 15/16

(52) U.S. Cl. 709/225; 709/201; 709/245

(57) ABSTRACT

System and method for managing a computer network using generic policy definitions. New policies can be defined, registered, and loaded dynamically without restarting the policy sub-system. An embodiment of the present invention uses generic policies written in Extensible Markup Language (XML) to standardize the policies and also to easily convert each standard policy definition to proprietary code specific to each device.

### TECHNICAL FIELD

The technical fields is computer networks, and more particularly improvements in management of policies in networks.

### BACKGROUND

A network typically includes a number of network devices that, among other functions, transmit or receive data. A local area network, commonly referred to as a LAN, is a privately owned network that facilitates communication among the devices coupled to the network via one of several data communication protocols such as Ethernet. To increase resource sharing and facilitate their supervision, computer systems, such as facsimile machines, desktop computers, printers, etc. are typically coupled to a LAN. The complexity that arises as a result of increasing the number and the variety of systems, which in the aggregate form a computer network, coupled with the variety of communication protocols that such devices are required to support, increase the knowledge base that is often required to manage such networks.

Networked devices may be managed by policies which supply rules pertaining to each individual device. Networks can be implemented with greater control when specified in terms of policies, which are rules that govern the operation of the network. The policies may relate to security, such as Virtual Private Network (VPN) policies, firewall policies, and application access policies. For example, a VPN policy might specify that passwords be set to expire after 90 days. More generally, the policies may relate to data management, such as backup policies, antivirus policies, and data management policies. In these policy-based networks, policies are defined through a descriptive programming language.

A firewall is a network gateway that filters packets and separates a proprietary corporate network, such as an intranet, from a public network, such as the Internet. Most firewalls are configured by means of a rule-base. A network administrator can implement a high-level corporate security policy by creating a low-level rule-base for each firewall interface in the corporate network.

A VPN device is a network device that secures the privacy of corporate data outside the perimeter of the corporate network. A network administrator can configure VPN devices so that corporate data sent over the public Internet, e.g., from the corporate headquarters to a remote company site, is adequately secured. This typically involves configuring settings for cryptographic key exchanges, choosing the appropriate encryption for sending data, e.g., IP packets, according to the destination, etc.

However, in a network with various types of devices, these devices usually have their own proprietary software. There are standards in the area of policy management for networks, but the standards narrowly focus on one particular area, e.g., a firewall policy, a password policy, etc. In order to add new devices, or to add or modify existing policies, the policy must be rewritten to communicate properly with each device in its proprietary software. Rewriting each policy is expensive in coding and testing time, and in a large network, may be difficult to update correctly and maintain.

### SUMMARY

What are described are systems and methods for managing a network using generic policy definitions. a system includes a plurality of devices in said network and a generic policy definition, that can be used to define a policy with a definition that is translatable into each of the device specific codes. Each of the devices have a device specific code. Each policy defined with the generic policy definition is defined using an interpretable language. A policy defined with the generic policy definition is an Extensible Markup Language Document Type Definition (XML DTD).

A method includes defining a policy using the generic policy definition and plugging the policy into a generic policy definition template. The generic policy definition and each policy defined with and plugged into the generic policy definition is defined using an interpretable language and the defined policy is a device independent definition that is translatable into the device codes.

A computer-readable medium for managing a network, the network including a plurality of devices, each with a device specific code and a generic policy definition, includes instructions for defining a policy using the generic policy definition and plugging the policy into a generic policy definition template. The generic policy definition and each policy defined with and plugged into the generic policy definition is defined using an interpretable language and each defined policy is a device independent definition that is translatable into the device codes.

A device, in a computer network that includes a plurality of devices, includes a device specific code and a generic policy definition. The generic policy definition defines a policy with a definition that the device translates into the device specific code, The generic policy definition is defined using an interpretable language.

An apparatus for managing a network, the network including a plurality of devices, each with a device specific code and a generic policy definition, includes instructions for defining a policy using the generic policy definition and plugging the policy into a generic policy definition template. The generic policy definition and each policy defined with and plugged into the generic policy definition is defined using an interpretable language and each defined policy is a device independent definition that is translatable into the device codes.

### DESCRIPTION OF THE DRAWINGS

The features, aspects, and advantages of the embodiments described herein will become better understood with regard to the following description, appended claims, and accompanying drawings where:

FIG. 1 depicts a flowchart showing the operation of an embodiment of a method for managing a computer network through a “pluggable” policy architecture.

FIG. 2 is a block diagram illustrating a network managed with embodiments of a method for managing a computer network through a “pluggable” policy architecture.

### DETAILED DESCRIPTION

New policies can be defined, registered, and loaded dynamically without restarting the policy sub-system. A policy subsystem could be implemented by a cluster of application servers that implements the policy logic. The methodology presented would prevent restart of the application servers. An embodiment of the present invention uses pluggable policies written in Extensible Markup Language (XML) to standardize the policies and also to easily convert each standard policy definition to proprietary code specific to each device.

In general, a DTD (Document Type Definition) is a definition of the structure of a document encoded in XML. XML is a simplified markup language tailored to structured document content.

A DTD is written using XML syntax. The DTD is encoded in a file which is intended to be processed, along with the file containing a particular document, by an XML parser. The DTD tells the parser how to interpret the document which was created according to that DTD. DTDs may be used to describe any document type. For example, a DTD may be created for documents of type “memo”. Memos typically contain “To” and “From” information. The DTD would contain definitional elements for these items, telling the parser that these elements are valid syntax for this document type, as well as defining the syntax of sub elements within these elements, etc.

When a user wishes to print or display a document encoded according to an XML DTD, the software (e.g., the parser, compiler or other application) uses the XML DTD file to determine how to process the contents of the XML document. The software may be an XSL (Extensible Stylesheet) stylesheet, which can be designed to create a viewable version of the XML document, or can be designed to use or manipulate the XML document.

XML is a tag language, where specially-designated constructs referred to as “tags” are used to delimit (or “mark up”) information. In the general case, a tag is a keyword that identifies what the data is which is associated with the tag, and is typically composed of a character string enclosed in special characters. “Special characters” means characters other than letters and numbers, which are defined and reserved for use with tags. Special characters are used so that a parser processing the data stream will recognize that this a tag. A tag is normally inserted preceding its associated data: a corresponding tag may also be inserted following the data, to clearly identify where that data ends. As an example of using tags, “<email>” could be used as a tag to indicate that the character string appearing in the data stream after this tag is to be treated as an e-mail address; the syntax “</email>” would then be inserted after the character string, to delimit where the e-mail character string ends.

XML is an “extensible” markup language in that it provides users the capability to define their own tags. This makes XML a very powerful language that enables users to easily define a data model, which may change from one document to another. When an application generates the tags (and corresponding data) for a document according to a particular XML data model and transmits that document to another application that also understands this data model, the XML notation functions as a conduit, enabling a smooth transfer of information from one application to the other. By parsing the tags of the data model from the received document, the receiving application can re-create the information for display, printing, or other processing, as the generating application intended it.

In embodiments of the present invention, policies are defined according to XML DTDs. Using XML DTDs allows the policy definitions to be standardized. Table 1 below illustrates a DTD that is a meta-definition for a policy. The DTD in Table 1 defines a policy template that can contain zero, one, or more policies.

TABLE 1
<?xml version='1.0' encoding='us-ascii'?>
<!-- DTD for meta policy definition -->
<!ELEMENT Policy Template (Description, Policy*)>

| | |
|---|---|
| <!ATTLIST Policy Template name | CDATA #REQUIRED> |
| <!ATTLIST Policy Template Type | CDATA #REQUIRED> |
| <!ELEMENT Description | (#PCDATA)> |

<!ELEMENT Policy (Description, CreatedOn, CreatedBy, ExpirationDate,
ModifiedOn, ModifiedBy, Category, SubCategory, PolicyDefinition)>

| | |
|---|---|
| <!ATTLIST Policy name | CDATA #REQUIRED> |
| <!ATTLIST Policy Type | CDATA #REQUIRED> |
| <!ELEMENT Description | (#PCDATA)> |
| <!ELEMENT CreatedOn | (#PCDATA)> |
| <!ELEMENT CreatedBy | (#PCDATA)> |
| <!ELEMENT EffectiveDate | (#PCDATA)> |

<!ELEMENT ExpirationDate (#PCDATA)>

| | |
|---|---|
| <!ELEMENT ModifiedOn | (#PCDATA)> |
| <!ELEMENT ModifiedBy | (#PCDATA)> |
| <!ELEMENT Category | (#PCDATA)> |
| <!ELEMENT SubCategory | (#PCDATA)> |
| <!ELEMENT PolicyDefinition | (#PCDATA)> |
| <!ELEMENT Default | (#PCDATA)> |
| <!ELEMENT Relevance | (#PCDATA)> |
| <!ELEMENT Sequence | (#PCDATA)> |

The PolicyDefinition element shown in Table 1 will contain the actual policy specific for an environment. A company policy would state that “Do not allow employees access to any pornographic sites or allow download from sites not in the approved list”. This statement would translated into its XML equivalent. DTDs will be defined for each type of implementation listed: firewall, Loadbalancer, VPN, audit, password, Access Control (XACML), host lockdown, antivirus, intrusion detection, data backup, and data management. It will be apparent to those skilled in the art that the list is not limited to these exemplary implementations, but may include other implementations as well.

Each element of the DTD shown above in Table 1 describes a defined aspect of the policy. The Description element generally describes the policy, including any particular requirements or restraints of the network. The CreatedOn element notes the date when the policy definition was created, while the CreatedBy element notes the creator of the policy definition. The EffectiveDate and ExpirationDate elements note the dates when the policy becomes active and when the policy expires, respectively. Usually, the expiration date is the date when an action becomes necessary. The ModifiedOn element notes the date when the policy definition was last modified, while the CreatedBy element notes who last modified the policy definition. The Category and SubCategory elements are defined by the user. For example, a Category element may be firewall and the SubCategory element is access control, or the Category element may be password and the SubCategory element would also be password. The Default element is defined by the user and notes the default for the particular policy. The Relevance element notes whether the policy is applied to a particular system. For example, a firewall policy will not apply to a printer. The Sequence element notes if the policy requires a particular sequence of application. Each element describes an aspect of the policy definition, but it should be understood that not all elements are necessary for each policy, and that each policy may require different elements than those described above.

Each type of policy will have a specific reader to implement the policy, allowing clients to easily create new types of policies and plug-in their reader. A reader is a piece of code that reads and interprets the XML policy definitions and enforces them. The policies defined at this level will not be device or application specific but will contain abstractions of the most common implementations. The XML DTD acts as a standard policy description that can be translated into device specific code. The translations from the abstracted policy to the device or application specific policy may be performed by any method known in the art.

The DTD below in Table 2 describes a generic policy definition that can be used if the policy can be described using <name, values> pattern.

TABLE 2
<!ELEMENT generic_policy (policy_attribute+)>
<!ELEMENT policy_attribute (attr_value+)>

| | |
|---|---|
| <!ATTLIST policy_attribute name | CDATA #REQUIRED> |

<!ATTLIST policy_attribute single_valued (true/false) “true”>

| | |
|---|---|
| <!ATTLIST policy_attribute data_type | (string/Boolean/date “string”> |

| | |
|---|---|
| <!ELEMENT display_name | (#PCDATA)> |

<!ELEMENT display_length (#PCDATA)>

| | |
|---|---|
| <!ELEMENT attr_value | (#PCDATA)> |

The following XML shows an example of lockdown policies using the
generic DTD.
<generic_policy>

<policy_attribute name = “deactivate_telnet” data_type =
“string” single_valued

= “false”>

display_name>“Deactivate Telnet service?“</display_name>
<attr_value>true</attr_value>

</policy_attribute>
<policy_attribute name = “console_accts” data_type =
“string” single_valued

= “false”>

display_name>”Accounts that should be able to login at the
console”</display_name>
<display_length>50</display_length>
<attr_value>root</attr_value>
<attr_value>administrator</attr_value>
</policy_attribute>

<policy_attribute name = “tcp_audit” data_type = “string”
single_valued =

“false”>

display_name>”Types of TCP services that need to be audited”
</display_name>
<display_length>25</display_length>
<attr_value>telnet</attr_value>
<attr_value>ftp</attr_value>
<attr_value>finger</attr_value>

/policy_attribute>

</generic_policy>

As can be seen in the example above in Table 2, various policies can be described with a single element value. In the “deactivate_telnet” policy, the value is set initially to false, and when the value changes to true, then action must be taken. In the “console_accts” policy, the policy accepts particular values, but when a single character is received, then action must be taken. Likewise, in the “tcp_audit” policy, the policy accepts several values, but when a single value is received, then action must be taken.

In the example above in Table 2, several generic policies are described in XML, in an abstract standardized definition that is device-independent. The XML can then be translated into device specific language though a translator. A translator is the software logic that takes a implementation agnostic policy and converts it into a implementation specific policy. E.g. converting a corporate internet download policy into firewall rules.

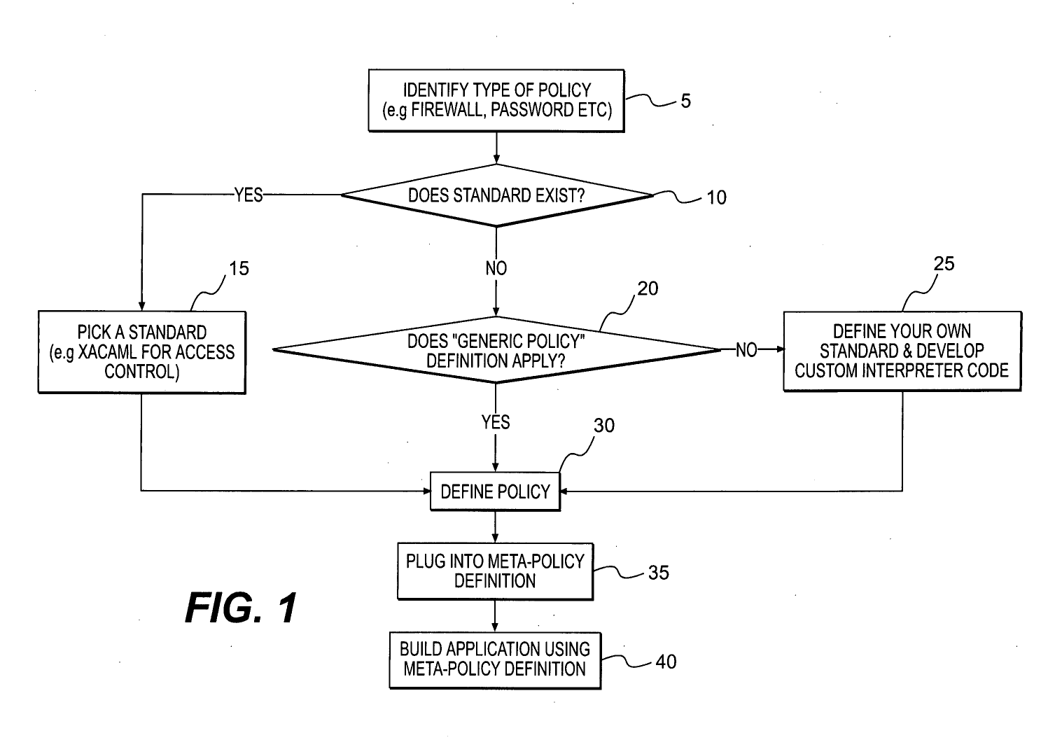

With reference now to FIG. 1, there is shown a flowchart, showing the flow of an embodiment of the present invention. Initially, the specific type of policy is determined (step 5). Then, the policy is evaluated to determine if a standard exists for the particular policy (step 10). If the policy has an existing standard, then that standard is selected (step 15). For example, XACML is an existing standard for access control. If the policy does not already have an existing standard, then the policy is evaluated to determine if the “generic policy” definition may be applied to the standard (step 20). The “generic policy” definition is that definition described above with respect to the <name, values> format. If the “generic policy” definition is not applicable to the policy, then a new standard must be written and new translator code must be written for the new standard (step 25). The new standard defined using XML is written or plugged into the meta-policy definition described above (step 35). Finally, an application is built using the meta-policy definition (step 40).

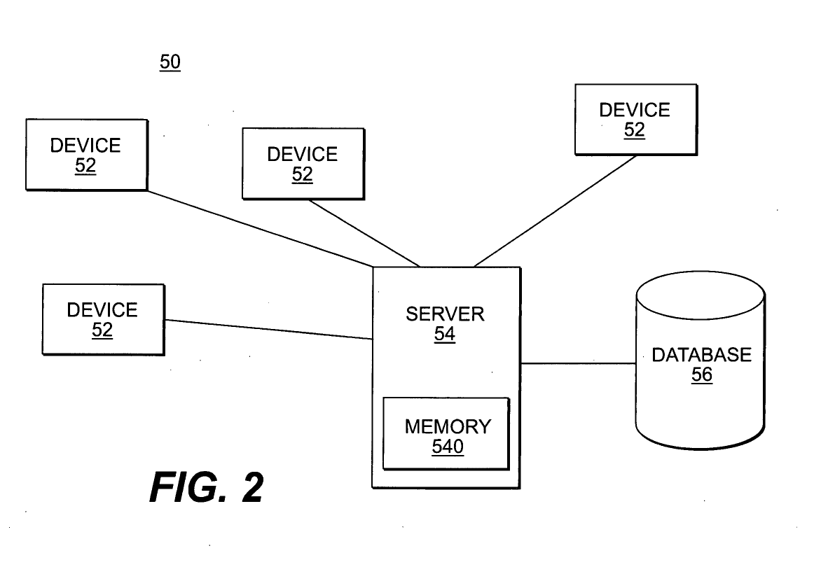

The policies would be stored in a database and shared across applications in an enterprise, as illustrated in FIG. 2. FIG. 2 illustrates a network 50 with a plurality of devices 52, a server 54, and a database 56 with a plurality of policies stored therein. The server 54 may include a memory 540, or other computer-readable medium, that includes one or more applications, including instructions for performing the method illustrated in FIG. 1. The applications would read the policies, interpret them and send as implementation specific data to enforcement points. E.g., XML policy definitions get converted to firewall rules and are sent to the appropriate firewalls. Policies are centrally defined by corporate security officers and policy makers.

The foregoing description of embodiments of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

1. A system for managing a network, said system comprising:
a plurality of devices in said network, wherein each of the devices have a device specific code; and
a generic policy definition, that can be used to define a policy with a definition that is translatable into each of the device specific codes, wherein each policy defined with the generic policy definition is defined using an interpretable language.

2. The system of claim 1, wherein each policy defined with the generic policy definition is an Extensible Markup Language Document Type Definition (XML DTD).

3. The system of claim 1, further comprising:
a plurality of translators that each translate a policy defined with the generic policy definition into the device specific code.

4. The system of claim 1, further comprising:
a policy defined with the generic policy definition, wherein the policy is applicable to a plurality of the devices.

5. The system of claim 1, further comprising:
a plurality of policies defined with the generic policy definition, wherein each policy is applicable to one or more of the devices.

6. The system of claim 1, further comprising:
a policy defined with the generic policy definition, wherein the policy includes a plurality of policies with a related purpose that are described with a single element value of the policy.

7. The system of claim 1, further comprising:
a plurality of policies defined with the generic policy definition, wherein each policy includes a plurality of elements, each element describing a defined aspect of the policy.

8. The system of claim 1, wherein the generic policy definition is used to define policies using a <names, values> pattern.

9. The system of claim 1, further comprising a computer readable medium containing instructions for performing the steps of:
defining a policy using the generic policy definition; and
plugging the policy into a generic policy definition template.

10. The system of claim 9, wherein the computer readable medium further contains instructions to perform the step of:
building an application using the policy plugged into the generic policy definition template.

11. A method for managing a network, the network including a plurality of devices, each with a device specific code and a generic policy definition, the method comprising:
defining a policy using the generic policy definition; and,
plugging the policy into a generic policy definition template, wherein the generic policy definition and each policy defined with and plugged into the generic policy definition is defined using an interpretable language and the defined policy is a device independent definition that is translatable into the device codes.

12. The method of claim 11, wherein each policy defined with the generic policy definition is an Extensible Markup Language Document Type Definition (XML DTD).

13. The method of claim 11, wherein the method further comprises:
determining whether a standard definition for the policy exists; and
if the standard definition for the policy exists, using the standard definition as the generic policy definition and a standard definition template as the generic policy definition template.

14. The method of claim 11, further comprising:
determining whether the generic policy definition applies to the policy.

15. The method of claim 14, further comprising:
if the generic policy definition does not apply, defining a new interpretable language policy definition; and
using the new interpretable language policy as the generic policy definition and a new interpretable language policy definition template as the generic policy definition template.

16. The method of claim 15, wherein the new interpretable language policy definition is a XML DTD.

17. The method of claim 11, further comprising:
identifying a type of the policy.

18. A computer-readable medium containing instructions for managing a network, the network including a plurality of devices, each with a device specific code and a generic policy definition, by:
defining a policy using the generic policy definition; and,
plugging the policy into a generic policy definition template, wherein the generic policy definition and each policy defined with and plugged into the generic policy definition is defined using an interpretable language and the defined policy is a device independent definition that is translatable into the device codes.

19. The computer-readable medium of claim 18, wherein each policy defined with the generic policy definition is an Extensible Markup Language Document Type Definition (XML DTD).

20. The computer-readable medium of claim 18 further containing instructions for:
determining whether a standard definition for the policy exists; and
if the standard definition for the policy exists, using the standard definition as the generic policy definition and a standard definition template as the generic policy definition template.

21. The computer-readable medium of claim 18 further containing instructions for:
determining whether the generic policy definition applies to the policy.

22. The computer-readable medium of claim 21 further containing instructions for:
if the generic policy definition does not apply, defining a new interpretable language policy definition; and
using the new interpretable language policy as the generic policy definition and a new interpretable language policy definition template as the generic policy definition template.

23. The computer-readable medium of claim 22, wherein the new interpretable language policy definition is a XML DTD.

24. The computer-readable medium of claim 18 further containing instructions for:
identifying a type of the policy.

25. An apparatus containing instructions for managing a network, the network including a plurality of devices, each with a device specific code and a generic policy definition, by:
defining a policy using the generic policy definition; and,
plugging the policy into a generic policy definition template, wherein the generic policy definition and each policy defined with and plugged into the generic policy definition is defined using an interpretable language and the defined policy is a device independent definition that is translatable into the device codes.

26. The apparatus of claim 25, wherein each policy defined with the generic policy definition is an Extensible Markup Language Document Type Definition (XML DTD).
